(19) United States
(12) Patent Application Publication
(10) Pub. No.: US 2025/0261013 A1
(43) Pub. Date: Aug. 14, 2025

(54) COMMUNICATION METHOD

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/193,674

(22) Filed: Apr. 29, 2025

Related U.S. Application Data
(63) Continuation of application No. PCT/JP2023/039398, filed on Nov. 1, 2023.

(30) Foreign Application Priority Data
Nov. 1, 2022 (JP) 2022-175869

(51) Int. Cl. H04W 24/08; H04W 36/30

(52) U.S. Cl. CPC H04W 24/08; H04W 36/30

(57) ABSTRACT

The present disclosure relates to a communication method in a mobile communication system. The communication method includes transmitting, by a transmission-end entity to a reception-end entity, first use condition information representing a first use condition under which a training model and/or a data set is to be used. Here, the training model is one of an untrained model that has not been trained and a trained model that has been trained. The data set is one of training data and inference data.

### RELATED APPLICATIONS

The present application is a continuation based on PCT Application No. PCT/JP2023/039398, filed on Nov. 1, 2023, which claims the benefit of Japanese Patent Application No. 2022-175869 filed on Nov. 1, 2022. The content of which is incorporated by reference herein in their entirety.

### TECHNICAL FIELD

The present disclosure relates to a communication method.

### BACKGROUND

In recent years, in the Third Generation Partnership Project (3GPP) (trade name), which is a standardization project for mobile communication systems, a study is underway to apply an Artificial Intelligence (AI) technology, particularly, a Machine Learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication method is a communication method in a mobile communication system. The communication method includes transmitting, by a transmission-end entity to a reception-end entity, first use condition information representing a first use condition under which a training model and/or a data set is to be used. Here, the training model is one of an untrained model that has not been trained and a trained model that has been trained. The data set is one of training data and inference data.

In an aspect, a communication method is a communication method in a mobile communication system. The communication method includes transmitting, by a transmission-end entity, a data set configured to be used in a training model to a reception-end entity including the training model without transmitting name information representing a name of the training model. Here, the training model is one of an untrained model that has not been trained and a trained model that has been trained. The data set is one of training data and inference data.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an arrangement example of functional blocks of the AI/ML technology according to the first embodiment.

FIG. 8 is a diagram illustrating an arrangement example of functional blocks of the AI/ML technology according to the first embodiment.

FIG. 9 is a diagram illustrating an arrangement example of functional blocks of the AI/ML technology according to the first embodiment.

FIG. 10 is a diagram illustrating a configuration example of a mobile communication system according to the first embodiment.

FIG. 11 is a diagram illustrating an example of an operation according to the first embodiment.

FIG. 12 is a diagram illustrating the operation example according to the second embodiment.

FIG. 13 is a diagram illustrating an operation example according to a third embodiment.

FIG. 14 is a diagram illustrating another operation example according to the third embodiment.

### DESCRIPTION OF EMBODIMENTS

When a machine learning technology is applied to a mobile communication system, how to utilize the machine learning technology has not yet been established.

An object of the present disclosure is to provide a communication method capable of determining whether a trained model or an untrained model can be used in a reception-end entity. Another object of the present disclosure is to provide a communication method capable of determining whether training data or inference data can be used in the reception-end entity.

### First Embodiment

A mobile communication system according to a first embodiment will be described with reference to the drawings. In the description of the drawings, the same or similar parts are denoted by the same or similar reference signs.

### Configuration of Mobile Communication System

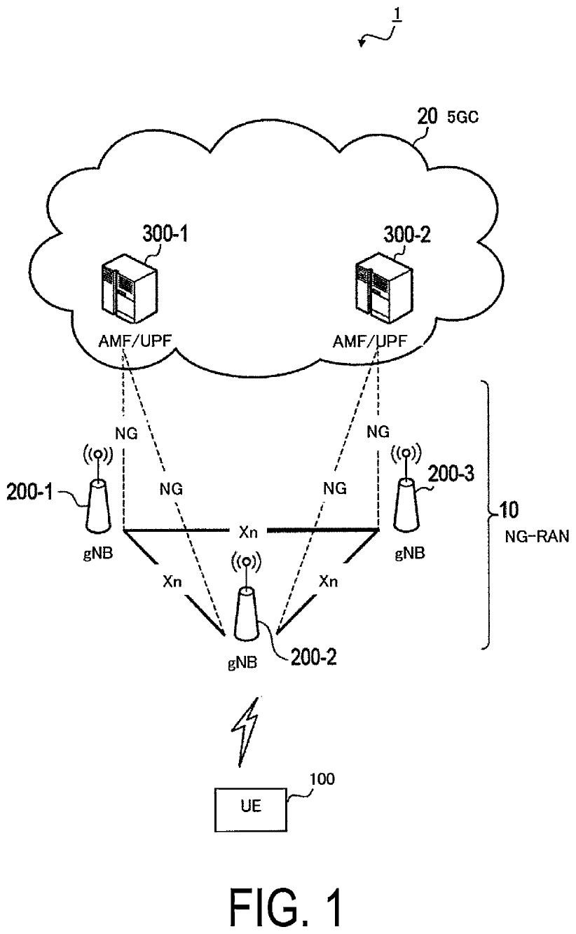

A configuration of a mobile communication system according to a first embodiment will be described. FIG. 1 is a diagram illustrating a configuration example of the mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

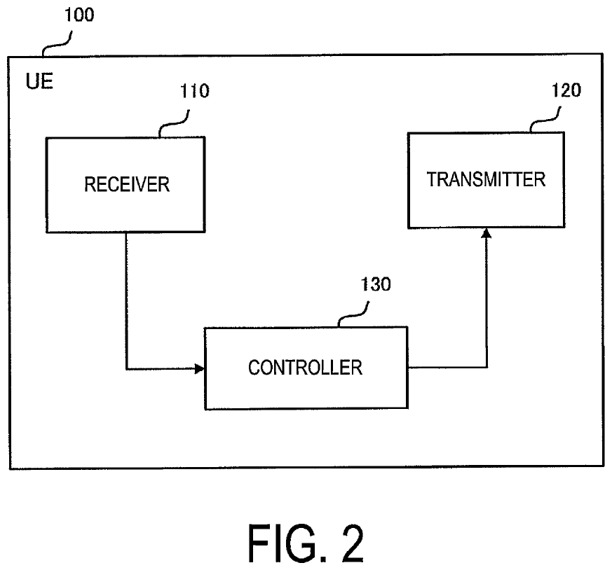

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

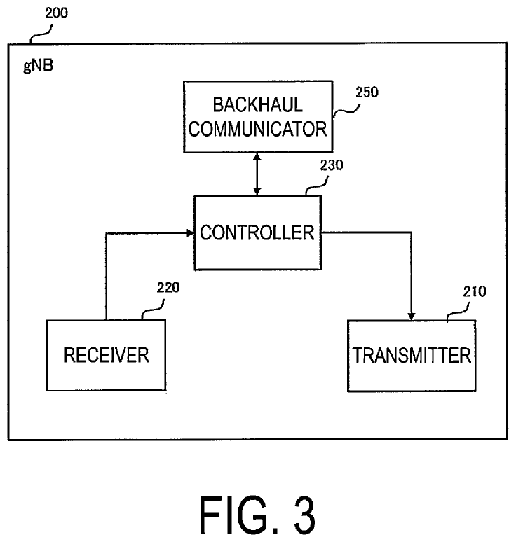

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

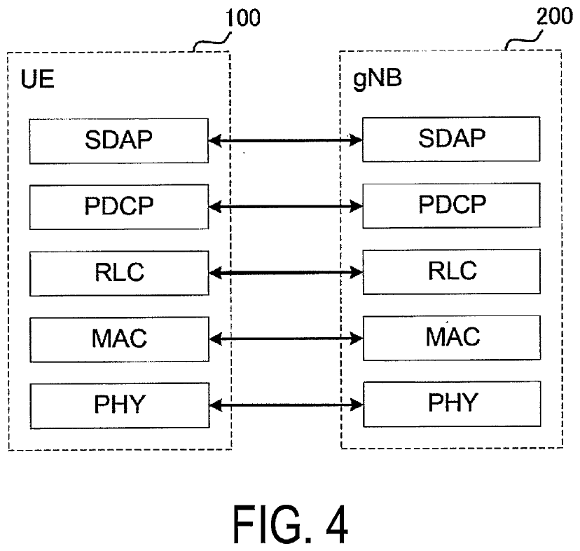

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

In NR, the UE 100 can use a bandwidth narrower than a system bandwidth (that is, a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QOS) control by the core network, and radio bearers, which are units for QoS control by the Access Stratum (AS). Note that, when the RAN is connected to the EPC, the SDAP need not be provided.

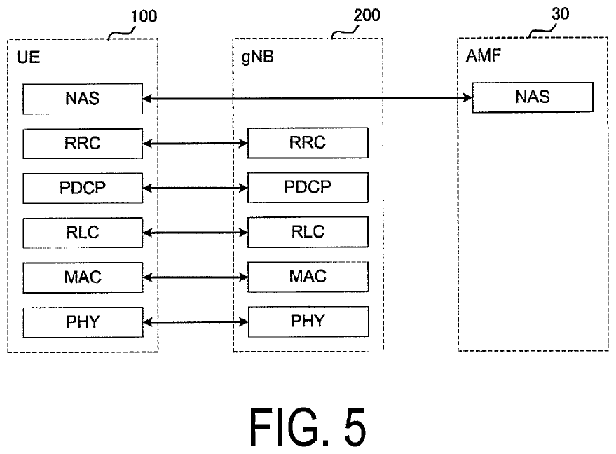

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### AI/ML Technology

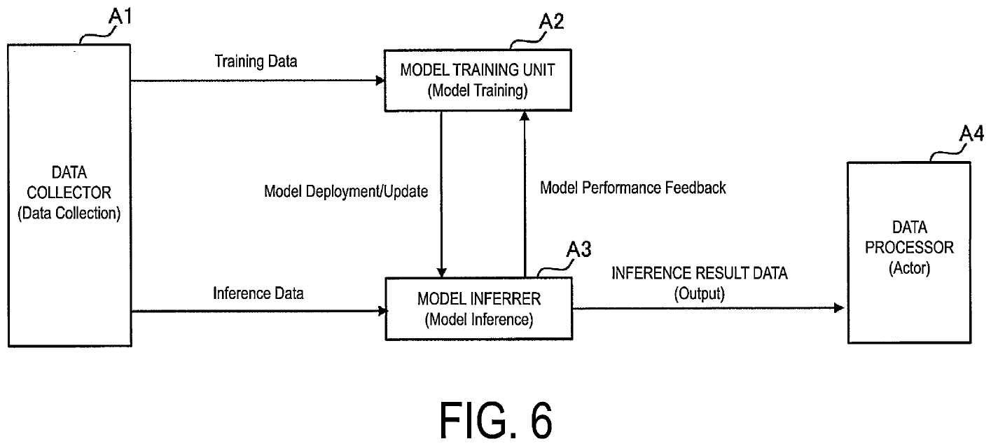

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model training unit A2, a model inferrer A3, and a data processor A4.

The data collector A1 collects input data, specifically, training data and inference data. The data collector A1 outputs the training data to the model training unit A2. The data collector A1 also outputs the inference data to the model inferrer A3. The data collector A1 may acquire data in the apparatus in which the data collector A1 is provided, as input data. The data collector A1 may acquire, as the input data, data in another apparatus.

The model training unit A2 performs model training. Specifically, the model training unit A2 optimizes parameters of the training model through machine learning using the training data, and derives (or deploys, or updates) the trained model. The model training unit A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the training data. The unsupervised learning is a method of not using correct answer data for the training data. For example, in the unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model training unit A2.

The data processor A4 receives the inference result data and performs processing that utilizes the inference result data.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1) “Channel State Information (CSI) feedback enhancement”
(2) “Beam management”
(3) “Positioning accuracy enhancement” Hereinafter, an arrangement example of the functional blocks will be described for each use case.

### 1. Arrangement Example of Functional Blocks in “CSI Feedback Enhancement”

The “CSI feedback enhancement” represents, for example, a use case where the machine learning technology is applied to the CSI fed back from the UE 100 to the gNB 200.

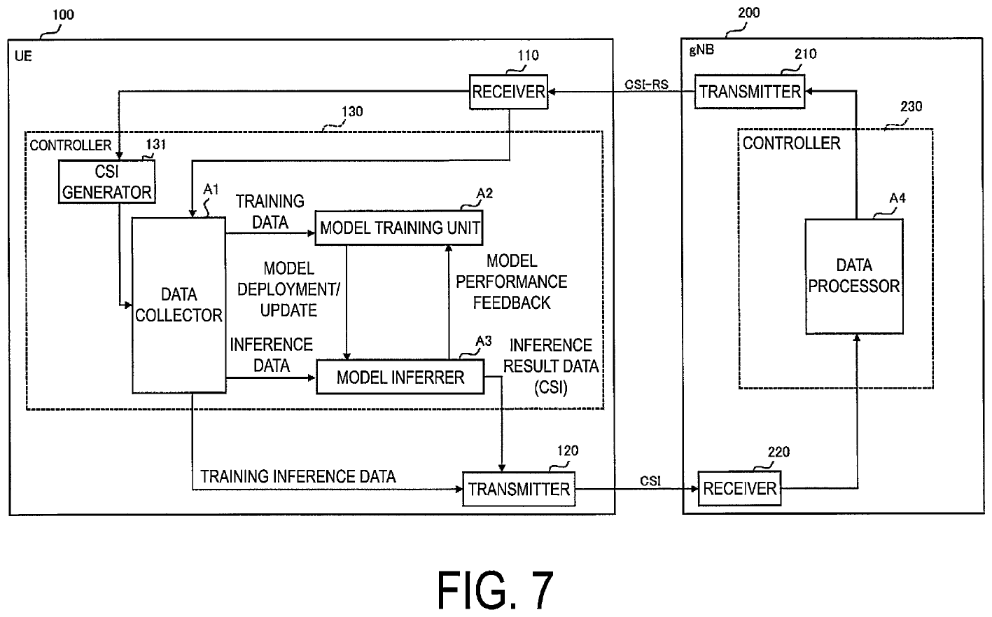

FIG. 7 is a diagram illustrating an arrangement example of the functional blocks in the “CSI feedback enhancement”. In the example of “CSI feedback enhancement” illustrated in FIG. 7, the controller 130 of the UE 100 includes the data collector A1, the model training unit A2, and the model inferrer A3. On the other hand, the controller 230 of the gNB 200 includes the data processor A4. In the “CSI feedback enhancement”, for example, the following processing is performed.

That is, the UE 100 estimates channel state information (CSI) based on a CSI reference signal (CSI-RS) received from the gNB 200. A CSI generator 131 generates (or estimates) CSI based on the CSI-RS. The data collector A1 collects the CSI-RS and the CSI. The model training unit A2 uses the CSI-RS and the CSI as training data to generate a trained model. The model inferrer A3 causes the CSI-RS and the CSI (that are punctured, for example) to be input to the trained model as inference data to obtain CSI as an inference result. The UE 100 transmits (or feeds back) the inference result (CSI) to the gNB 200 as inference result data. The UE 100 can deploy a trained model with a predetermined accuracy or higher by repeating model training. The inference result obtained by using the trained model deployed as described above is expected to have a predetermined accuracy or higher.

Note that the CSI includes at least one selected from the group consisting of a Channel Quality Indicator (CQI), a Precoding Matrix Indicator (PMI), and a Rank Indicator (RI). The CSI is used in the gNB 200 for downlink scheduling and the like.

In the example illustrated in FIG. 7, the training data is “CSI-RS” and “CSI”, and the inference data is also “CSI-RS” and “CSI”. Hereinafter, the training data and/or the inference data may be referred to as a “data set”.

In the “CSI feedback enhancement”, for example, at least one selected from the group consisting of the following data and/or information may be used as the data used for the data set in addition to the “CSI-RS” and the “CSI”.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS or may be other received signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)

### 2. Arrangement Example of Functional Blocks in “Beam Management”

The “beam management” represents, for example, a use case where the machine learning technology is used to manage which beam is an optimum beam among the beams transmitted from the gNB 200.

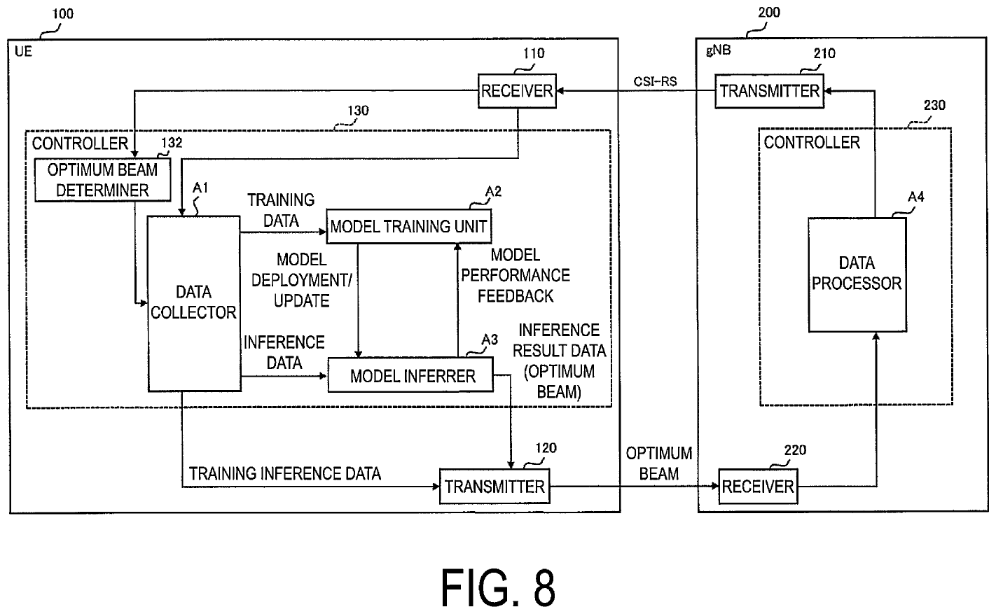

FIG. 8 is a diagram illustrating an arrangement example of the functional blocks in the “beam management”. In the example of the “beam management” illustrated in FIG. 8, the controller 130 of the UE 100 includes the data collector A1, the model training unit A2, and the model inferrer A3. On the other hand, the controller 230 of the gNB 200 includes the data processor A4. For example, the following processing is performed.

That is, an optimum beam determiner 132 of the UE 100 determines the optimum beam based on the CSI-RS. The optimum beam determiner 132 may determine the optimum beam based on the reception quality of the CSI-RS. The data collector A1 collects the CSI-RS and the optimum beam (information indicating the optimum beam). The model training unit A2 generates a trained model using the CSI-RS and the optimum beam as training data. The model inferrer A3 causes the CSI-RS and the optimum beam to be input to the trained model as inference data, and obtains the optimum beam as an inference result. The UE 100 transmits the inference result (optimum beam) to the gNB 200 as inference result data.

In the “beam management”, in addition to the “CSI-RS” and the “optimum beam”, for example, at least one selected from the group consisting of the following data or information may be used as the data used for the data set.
(Y1) Synchronization Signal Block (SSB) received from the gNB 200
(Y2) RSRP, RSRQ, SINR, or the output waveform of the AD converter (a measurement target of these data may be the CSI-RS or may be other received signals received from the gNB 200)
(Y3) BER or BLER ((BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

### 3. Arrangement Example of Functional Blocks in “Positioning Accuracy Enhancement”

The “positioning accuracy enhancement” represents, for example, a use case where the accuracy of the position information measured by the UE 100 is enhanced using the machine learning technology.

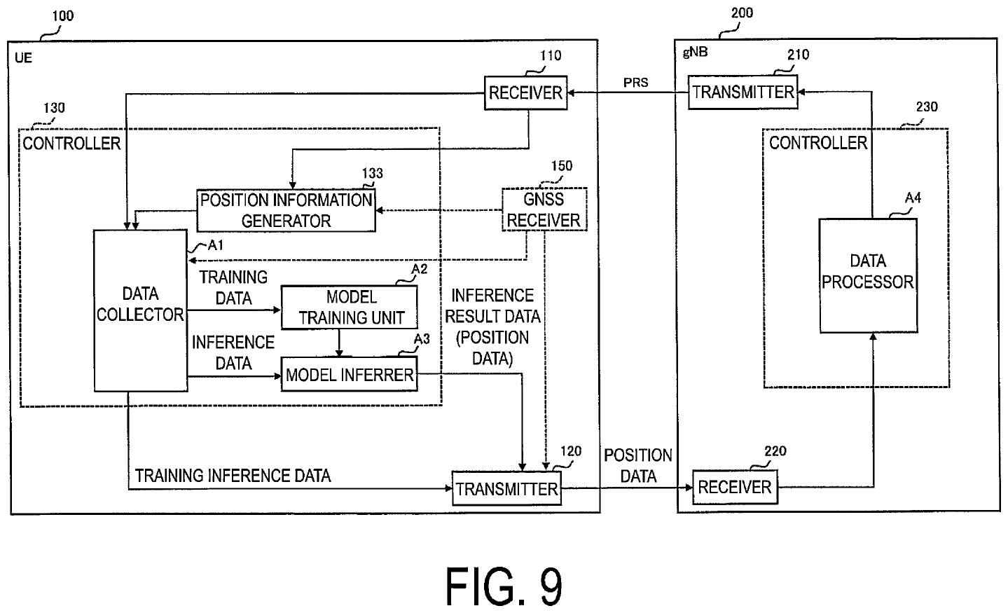

FIG. 9 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model training unit A2, and the model inferrer A3. On the other hand, the controller 230 of the gNB 200 includes the data processor A4. In the “positioning accuracy enhancement”, for example, the following processing is performed.

That is, a position information generator 133 of the UE 100 generates position data of the UE 100 based on a Positioning Reference Signal (PRS) received from the gNB 200. The position information generator 133 may receive a GNSS signal received by a Global Navigation Satellite System (GNSS) receiver 150 and generate the position data of the UE 100 based on the GNSS signal. The data collector A1 collects the PRS (or GNSS signal) and the position data. The model training unit A2 generates a trained model using the PRS (or the GNSS signal) and the position data as training data. The model inferrer A3 causes the PRS (or GNSS signal) and the position data to be input to the trained model as inference data, and obtains the position data as an inference result. The UE 100 transmits the inference result (position data) to the gNB 200.

In the “positioning accuracy enhancement”, in addition to the “PRS”, the “GNSS signal”, and the “position data”, for example, at least one selected from the group consisting of the following data or information may be used as the data used for the data set.
(Z1) RSRP, RSRQ, Signal-to-interference-plus-noise ratio (SINR), or the output waveform of the AD converter (a measurement target of these data may be the PRS or may be other received signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a received signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(X7) Moving speed of the UE 100 (the moving speed may be measured by the GNSS receiver 150 or may be measured by the speed sensor in the UE 100)

Although the arrangement examples of the functional blocks used in the AI/ML technology have been described above, the arrangement examples are not limited to those illustrated in FIGS. 7 to 9. For example, the data collector A1, the model training unit A2, and the model inferrer A3 may be disposed in the gNB 200, and the data processor A4 may be disposed in the UE 100. For example, in the “CSI feedback enhancement”, the gNB 200 estimates CSI based on a Sounding Reference Signal (SRS) transmitted from the UE 100. Then, the model training unit A2 in the gNB 200 derives a trained model based on the SRS and the CSI. The model inferrer A3 in the gNB 200 causes the SRS and the CSI to be input to the trained model to obtain inference result data (CSI). The gNB 200 transmits (feeds back) the CSI to the UE 100.

### Communication Method According to First Embodiment

A communication method according to the first embodiment will be described.

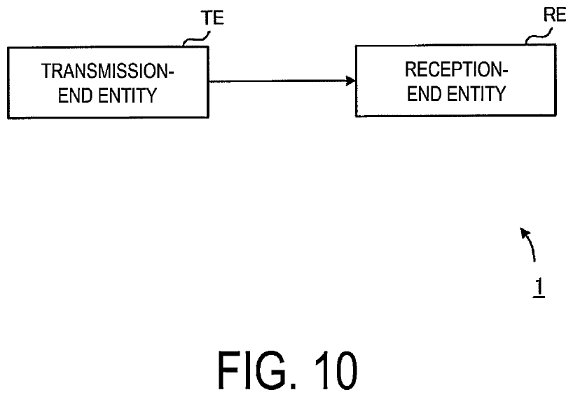

FIG. 10 is a diagram illustrating a configuration example of the mobile communication system 1 according to the first embodiment. As illustrated in FIG. 10, the mobile communication system 1 includes a transmission-end entity TE and a reception-end entity RE.

The transmission-end entity TE may be the UE 100. In this case, the reception-end entity RE may be a network apparatus (e.g., gNB 200, or AMF 300, etc.).

The transmission-end entity TE may also be a network apparatus. In this case, the reception-end entity RE may be the UE 100.

Note that, in FIG. 10, a plurality of reception-end entities RE may be present. The transmission-end entity TE may perform transmission to a plurality of reception-end entities RE.

For example, the following case is assumed. That is, the transmission-end entity TE derives (or creates) a trained model and transmits the derived trained model to the reception-end entity RE. In this case, the transmission-end entity TE may also transmit, to the reception-end entity RE, the inference data used in the trained model. The transmission-end entity TE transmits, to the reception-end entity RE, an untrained training model (which may hereinafter be referred to as an “untrained model”) which has not been trained. In this case, the transmission-end entity TE may also transmit, to the reception-end entity RE, the training data used in the untrained model.

However, the reception-end entity RE may not know whether the reception-end entity RE itself can use the trained model received from the transmission-end entity TE. For example, this applies to the case where the memory capacity necessary for using the trained model is requested and the reception-end entity RE does not know how much the memory capacity is. The reception-end entity RE may not know whether the reception-end entity RE itself can use the inference data received from the transmission-end entity TE. The reception-end entity RE may not know whether the reception-end entity RE itself can use the untrained model or the training data.

Accordingly, the reception-end entity cannot use the received trained model, and the trained model transmitted by the transmission-end entity may be useless. The inference data, the untrained model, and the training data may also be useless.

Thus, an object of the first embodiment is to enable the reception-end entity RE to determine whether the trained model or the untrained model can be used. An object of the first embodiment is to enable the reception-end entity RE to determine whether the training data or the inference data can be used.

Accordingly, in the first embodiment, the transmission-end entity (for example, the transmission-end entity TE) transmits, to the reception-end entity (for example, the reception-end entity RE), first use condition information representing a first use condition for using model data representing a training model and/or a data set. Here, the training model is either an untrained model that has not been trained or a trained model that has been trained. The data set is one of training data and inference data.

Accordingly, for example, the reception-end entity RE can determine whether training or inference can be performed based on the first use condition information using the training model received from the transmission-end entity TE. The reception-end entity RE can determine whether training or inference can be performed using the data set received from the transmission-end entity TE based on the first use condition information.

As described above, the “training model” may be an “untrained model”. Here, the “training model” may be a “trained model”. The “training model” is one of an “untrained model” and a “trained model”. The “data set” may be “training data”. The “data set” may be “inference data”. The “data set” is one of “training data” and “inference data”.

As described above, the “training model” and/or the “data set” may be referred to as “model data”. The “model data” may include a “training model” and/or a “data set”.

### Example of Operation According to First Embodiment

An example of an operation according to the first embodiment will be described.

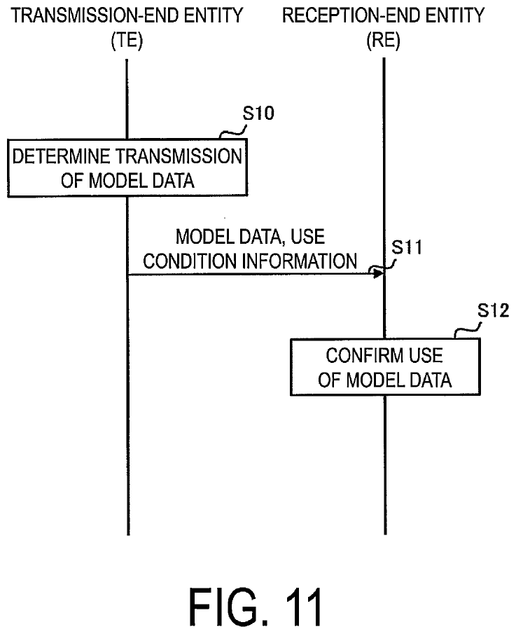

FIG. 11 illustrates an example of an operation according to the first embodiment.

As illustrated in FIG. 11, in step S10, the transmission-end entity TE determines to transmit model data.

In step S11, the transmission-end entity TE broadcasts the model data and the use condition information (e.g., the first use condition information). The transmission-end entity TE may transmit the model data and the use condition information to the reception-end entity RE. The use condition information represents a use condition (for example, a first use condition) for using the model data in the reception-end entity RE.

First, the use condition may represent the type of the data set (data set included in the model data) transmitted from the transmission-end entity TE to the reception-end entity RE. For example, in the use case of the “CSI feedback enhancement”, the type is “CSI”, “RSRP”, and “CSI”.

Second, the use condition may represent a position or a place where the model data is used. Examples of the position or the place include position information, a place name, a cell name, a cell ID, Tracking Area Identity (TAI), identification information of a Registration Area (RA), and a Public Land Mobile Network Number (PLMN).

Third, the use condition may represent a Required resource. The required resource may be represented by memory capacity. The required resource may be represented by the size of the model data. The required resource may be represented by a computer performance index (for example, Floating-point Operations Per Second (FLOPS) or the like) (or CPU power) required when the model data is executed.

Fourth, for example, the use condition may be as listed below.

TABLE 1

| Use condition | Application example |
|---|---|
| Use case type | “CSI feedback enhancement”, “beam management”, “positioning |
| | accuracy enhancement”, or the like |
| Applied model name, or | Product name of a training model, and the like |
| recommended model | |
| Model format | PyTorch, which is a machine learning library, Open Neural |
| | Network Exchange (ONNX), which is a format of a machine |
| | training model, or the like |
| Model architecture | Deep Neural Network (DNN), RandomForest, which is a machine |
| | learning algorithm, or the like |
| TIME | Represents time information or a season. May be indicated in a |
| | range form. |
| Moving speed | May be indicated in a range form. |
| Altitude | May be indicated in a range form. |
| Target type | Indicates the type of an apparatus used. For example, smart phone, |
| | IoT, V2X, or the like. May be indicated in a range form. |
| Target model name | Indicates the model name of the apparatus used. Moon-1, Sun-1, |
| | or the like. May be indicated in a range form. |
| Antenna structure | Indicates an antenna structure required in use. For example, “2x2 |
| | MIMO” or the like. May be indicated in a range form. |
| Runtime type | Indicate whether a program used when model data is used is |
| | Runtime (whether the program has only an execution function). |
| Acquisition source of the | Indicates the acquisition source (download source) of the |
| execution program | execution program if the program used when the model data is |
| | used is not Runtime. |
| Information of an | Indicates the slice to which the model data is applicable. May |
| applicable slice | indicate a single slice or a slice group. |

Note that the transmission-end entity TE may transmit the use condition information and the model data (simultaneously). Alternatively, the transmission-end entity TE may transmit the model data after transmitting the use condition information.

First, the transmission-end entity TE may transmit the use condition information using an information element including the use condition information.

When the transmission-end entity TE is the UE 100 and the reception-end entity RE is the gNB 200, the transmission-end entity TE may perform transmission using an RRC message including the information element or may perform transmission using a MAC CE including the information element. When the transmission-end entity TE is the gNB 200 and the reception-end entity RE is the UE 100, the transmission-end entity TE may also perform transmission using an RRC message or a MAC CE.

When the transmission-end entity TE is the UE 100 and the reception-end entity RE is the AMF 300, the transmission-end entity TE may perform transmission using a NAS message including the information element. Similarly, when the transmission-end entity TE is the AMF 300 and the reception-end entity RE is the UE 100, the transmission-end entity TE may transmit the information element using NAS messages.

When the transmission-end entity TE is the UE 100 and the reception-end entity RE is an Over The Top (OTT) server, the transmission-end entity TE may by use a TCP/IP protocol packet data to transmit the packet data including the data set. When the transmission-end entity TE is an OTT server and the reception-end entity RE is the UE 100, the data set may also be transmitted using the TCP/IP protocol packet data. Note that the OTT server is a server that distributes media contents such as video and/or audio distributed over the Internet.

Second, the transmission-end entity TE may transmit the use condition information using a predetermined bit string to which presence or absence of the use condition information is mapped. For example, it is assumed that the first bit of the predetermined bit string represents the “CSI-RS”, the second bit represents the “RSRP”, the third bit represents the “RSRQ”, and the fourth bit represents the “SINR”. In such a case, the transmission-end entity TE can transmit the use condition information indicating that the “CSI-RS”, the “RSRP”, and the “RSRQ” are used as the data set by transmitting the predetermined bit string “1110” as the use condition information.

In step S12, the reception-end entity RE checks the received use condition information and checks whether the model data can be used. The reception-end entity RE may compare the use condition information with its own computing capabilities or the like to check whether the use condition indicated in the use condition information is satisfied. When the reception-end entity RE determines that the use condition is satisfied, that is, the model data can be used, the reception-end entity RE directly uses the model data. On the other hand, when the reception-end entity RE determines that the use condition is not satisfied, that is, the model data cannot be used, the reception-end entity RE does not use the model data. In the latter case, the reception-end entity RE may discard the model data. The reception-end entity RE may transmit information to the transmission-end entity TE indicating that the model data cannot be used. In this case, by transmitting an RRC message or a MAC-CE including information indicating that the model data cannot be used, the reception-end entity RE may transmit the information to the transmission-end entity TE. When the reception-end entity RE transmits, to the transmission-end entity TE, information indicating that the model data cannot be used, the reception-end entity RE may transmit, to the transmission-end entity TE, a condition for allowing the model data to be used. The reception-end entity RE may transmit the condition after receiving the model data. The reception-end entity RE may transmit the condition before receiving the model data. The condition may be transmitted by using an RRC message or a MAC CE.

### Another Operation Example According to First Embodiment

In the first embodiment, an example has been described in which the transmission-end entity TE transmits the use condition information to the reception-end entity RE, but the present disclosure is not limited thereto. For example, the reception-end entity RE may transmit available use condition information to the transmission-end entity TE. The reception-end entity RE may transmit the use condition information using an RRC message, a MAC CE, or the like. In response to the reception of the use condition information, the transmission-end entity TE may transmit, to the reception-end entity RE, the model data satisfying the use condition included in the use condition information (step S11).

### Second Embodiment

A second embodiment will be described. In the second embodiment, differences from the first embodiment will mainly be described.

In the first embodiment, an example has been described in which the transmission-end entity TE transmits the training model. In the first embodiment, a case has also been described where the transmission condition includes the model name.

For example, the following case is assumed. That is, the reception-end entity RE includes a plurality of training models. The transmission-end entity TE transmits a plurality of training model names to the reception-end entity RE in order to designate all of the plurality of training models of the reception-end entity RE.

However, when a plurality of training model names are transmitted, the amount of transmission data increases as compared with the case where no training model name is transmitted.

Thus, in the second embodiment, an example will be described in which the transmission-end entity TE transmits a data set instead of transmitting the name of the training model. Specifically, the transmission-end entity (for example, the transmission-end entity TE) transmits a data set usable for the training model to the reception-end entity (for example, the reception-end entity RE) including the training model without transmitting name information representing the name of the training model.

As described above, in the second embodiment, since no training model name is transmitted, the amount of transmission data can be reduced compared with the case where the training model name is transmitted. When the reception-end entity RE can use the received data set, the reception-end entity RE can directly use the data set for the training model, and when the reception-end entity RE cannot use the received data set, the reception-end entity RE can avoid using the data set. Accordingly, the reception-end entity RE can appropriately process the received data set.

### Operation Example According to Second Embodiment

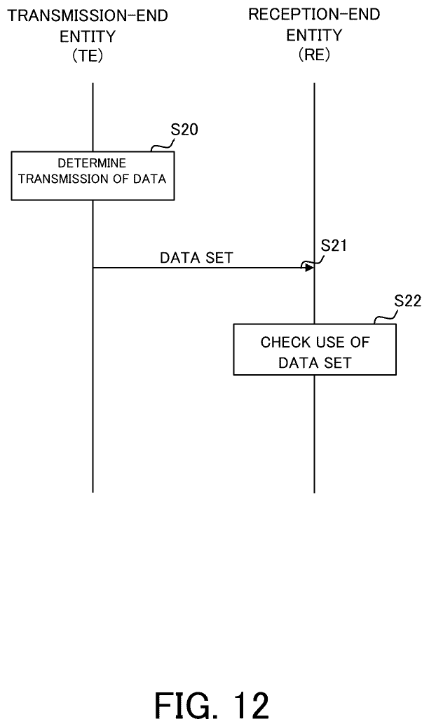

FIG. 12 is a diagram illustrating an operation example according to the second embodiment. Note that the reception-end entity RE is assumed to include one or more training models before the operation illustrated in FIG. 12 is started.

As illustrated in FIG. 12, in step S20, the transmission-end entity TE determines to transmit a data set to the reception-end entity RE. The data set can be used in the training model of the reception-end entity RE.

In Step S21, the transmission-end entity TE broadcasts the data set. The transmission-end entity TE may transmit the data set to the reception-end entity RE.

First, when the transmission-end entity TE is the UE 100 and the reception-end entity RE is the gNB 200, the transmission-end entity TE may perform transmission using an RRC message (or MAC CE) including the data set. When the transmission-end entity TE is the gNB 200 and the reception-end entity RE is the UE 100, the data set may be transmitted using an RRC message (or MAC CE).

Second, when the transmission-end entity TE is the UE 100 and the reception-end entity RE is the AMF 300, the transmission-end entity TE may perform transmission using a NAS message including the data set. When the transmission-end entity TE is the AMF 300 and the reception-end entity RE is a UE 100, the data set may also be transmitted using a NAS message.

Third, when the transmission-end entity TE is the UE 100 and the reception-end entity RE is the OTT server, the transmission-end entity TE may transmit packet data including the data set using TCP/IP protocol packet data. When the transmission-end entity TE is the OTT server and the reception-end entity RE is a UE 100, the data set may also be transmitted using TCP/IP protocol packet data.

Note that the transmission-end entity TE may transmit the training model together with the data set to the reception-end entity RE. The data set may be used for the training model. The data set may not need to be used in the training model (or may be used in a training model already present in the reception-end entity RE).

In a step S22, the reception-end entity RE checks whether the received data set is available. When the received data set is available, the reception-end entity RE uses the data set for the training model, and when the received data set is not available, the reception-end entity RE avoids using the data set for the training model. In the latter case, the reception-end entity RE may discard the data set. In this case, the reception-end entity RE may transmit, to the transmission-end entity TE, information indicating that the data set has been discarded. The information may be transmitted using an RRC message, a MAC CE, or a NAS message. The reception-end entity RE may also transmit to the transmission-end entity TE the reason for the discarding (for example, the target data cannot be used). The reception-end entity RE may transmit, to the transmission-end entity TE, information indicative of conforming data set (e.g., identification information of the conforming data set). The reception-end entity RE may transmit, to the transmission-end entity TE, the information representing the discarding as well as the information indicating the reason for the discarding and the information indicating the conforming data set. Information indicating the reason for the discarding and the conforming data set may also be transmitted using an RRC message, a MAC CE, or a NAS message.

### Another Operation Example According to Second Embodiment

In step S21, the transmission-end entity TE may transmit, together with the data set, the type of a use case in which the data set is used. For example, when the data set is the “CSI-RS”, there are two cases in which the “CSI-RS” is used in the “CSI feedback enhancement” and in the “beam management”. By transmitting the use case type, the transmission-end entity TE can notify the reception-end entity RE in which use case the data set is used.

### Third Embodiment

A third embodiment will be described. Also in the third embodiment, differences from the first embodiment will mainly be described.

For example, the following case is assumed. That is, the UE 100 derives a trained model. The trained model is a model derived in an “urban”. In such a case, the UE 100 desirably connects to a cell in an “urban” environment, rather than a cell in a “rural” environment, to cause the trained model to make an inference.

Thus, an object of the third embodiment is to enable the UE 100 to appropriately connect to a cell in which the training model can be used.

Accordingly, in the third embodiment, first, the user equipment (for example, the UE 100) transmits second use condition information representing a second use condition for using the training model to the base station (for example, the gNB 200) based on the first use condition information (for example, the use condition information received from the transmission-end entity TE). Second, the user equipment connects to a cell that satisfies the second use condition.

Accordingly, for example, the UE 100 can be connected to an appropriate cell that satisfies the use condition (or the second use condition) for executing the training model.

### Operation Example According to Third Embodiment

An operation example according to the third embodiment will be described.

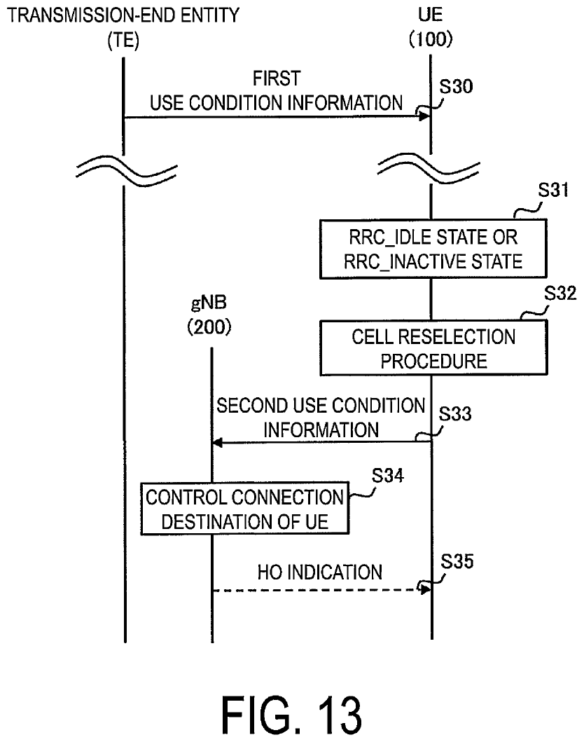

FIG. 13 is a diagram illustrating an operation example according to the third embodiment. In the description of the operation example illustrated in FIG. 13, the UE 100 is assumed to already include a training model.

As illustrated in FIG. 13, in step S30, the transmission-end entity TE transmits, to UE 100, the use condition information (or the first use condition information) of the training model of UE 100. The use condition information may be transmitted using an RRC message, a MAC CE, or a NAS message.

In step S31, the UE 100 transitions to the RRC idle state or the RRC inactive state.

In step S32, the UE 100 executes a cell reselection procedure. For example, the UE 100 selects a cell conforming to the training model and performs the cell reselection procedure with the highest frequency-priority for the cell. Alternatively, the UE 100 may select a tracking area conforming to the training model, and perform the cell reselection procedure with the highest priorities for the cells in the tracking area. Note that the cell ID of the cell and the tracking area identifier (Tracking Area Code (TAC)) of the tracking area are broadcast from the gNB 200 using system information. The UE 100 camps on the cell reselected by the cell reselection procedure.

In step S33, when transitioning to the RRC connected state, the UE 100 transmits, to the gNB 200, use condition information (or second use condition information) representing the use condition (or second use condition) of the training model. The first use condition may be a use condition of the training model requested by the transmission-end entity TE. The second use condition may be a use condition of the training model requested by the UE 100. The first use condition and the second use condition may be different from each other or may be the same. For example, the first use condition is “rural” and the second use condition is “urban”.

First, the UE 100 may transmit the second use condition information in a random access procedure for the cell reselected in step S32 (or the camped-on cell). In this case, the UE 100 may include the second use condition information in the MSG3 (for example, the RRC configuration request (RRCSetupRequest) message or the RRC resume request (RRCResumeRequest) message) and transmit the MSG3.

Second, the UE 100 may transmit the second use condition information after entering the RRC connected state. In this case, the UE 100 may include the second use condition information in a UE assistance information (UEAssistanceInformation) message, and transmit the UE assistance information message to the gNB 200. Alternatively, the UE 100 may include the second use condition information in a UE capability information (UECapabilityInformation) message, and transmit the UE capability information message to the gNB 200. Alternatively, the UE 100 may transmit, to the AMF 300, an NAS message including the second use condition information. Alternatively, the UE 100 may transmit, to the gNB 200, a measurement report including the second use condition information, with the transmission triggered by confirming that the first use condition and the second use condition are different. When the gNB 200 may transmit, to the UE 100, an RRC reconfiguration (RRCReconfiguration) message a conditional including reconfiguration (conditionalReconfiguration) indicating that the measurement report is transmitted using the confirmation as a trigger, the UE 100 may transmit the measurement report.

In step S34, gNB 200 controls the connection destination of UE 100 in accordance with the second use condition. For example, upon confirming that the UE 100 is connected to the cell satisfying the second use condition, the gNB 200 ends the series of processing operations. In this case, the UE 100 is connected to the cell reselected by the cell reselection procedure as a cell satisfying the second use condition.

On the other hand, upon confirming that the UE 100 is not connected to the cell satisfying the second use condition, the gNB 200 may perform processing of connecting the UE 100 to the cell satisfying the second use condition. In step S35, the gNB 200 may give the UE 100 an instruction to hand over to the cell. In this case, in response to receiving the measurement report in step S33, the gNB 200 may transmit, to the UE 100, an RRC reconfiguration (RRCReconfiguration) message including a command to hand over to the cell. In response to reception of the message, the UE 100 performs processing of connecting to a cell that satisfies the second use condition, thereby enabling connection to the cell.

### Another Operation Example 1 According to Third Embodiment

In the third embodiment, an example has been described in which the UE 100 performs the cell reselection procedure and connects to the cell applied to the training model (or the cell satisfying the second use condition), but the present disclosure is not limited thereto. For example, the UE 100 may perform a cell selection procedure to connect to a cell that conforms to the training model.

In this case, in step S31 in FIG. 13, the UE 100 enters a power-on state instead of the RRC idle state or the RRC inactive state.

In step S32, instead of the cell reselection procedure, a cell selection procedure is executed. In the cell selection procedure, the UE 100 may select a cell conforming to the training model, and may perform the cell selection procedure with the highest frequency-priority for the cell.

### Another Example 2 According to Third Embodiment

In the third embodiment, an example has been described in which the UE 100 performs the cell reselection procedure and connects to the cell applied to the training model (or the cell satisfying the second use condition), but the present disclosure is not limited thereto. For example, in this case, the UE 100 may perform a slice-specific cell reselection procedure to connect to the cell conforming to the training model. Note that the slice-specific cell reselection procedure is, for example, a procedure that enables reselection to a cell supporting a desired network slice.

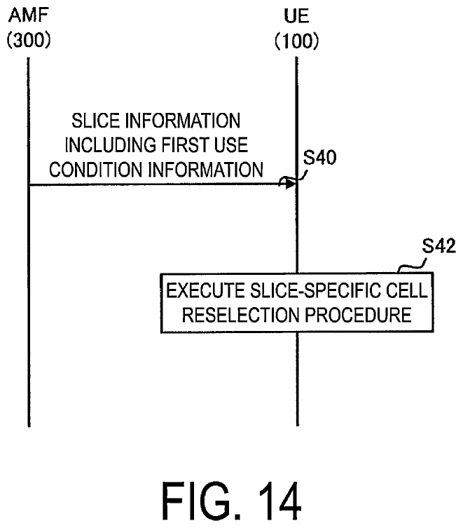

FIG. 14 is a diagram illustrating another Operation Example 2 according to the third embodiment.

As illustrated in FIG. 14, in step S40, the AMF 300 transmits, to the UE 100, slice information including the first use condition. The slice information may include the priorities of one or more slices. The slice information may be a Network Slice Access Stratum Group (NSAG) message.

In step S42, the UE 100 performs a splice-specific cell reselection procedure. The UE 100 may perform the procedure with the frequency supporting the cell as the highest priority to preferentially enable selection of the cell conforming to the training model. In this case, the UE 100 can connect to the cell by executing a random access procedure on the cell on which the UE 100 has camped.

When a PDU session is established with the network, the UE 100 may request, from the network, a connection to a network slice that conforms to the training model of the UE 100. To be specific, the UE 100 may transmit a PDU Session Establishment Request message to the AMF 300, where the PDU session establishment request includes a request for a connection to the network slice. The network (for example, the AMF 300) may transmit a message (for example, a PDU Session Establishment Accept message) for permitting connection to the cell supporting the network slice to the UE 100. As a result, the UE 100 can perform model training or inference using a network slice conforming to the training model of the UE 100.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

In the first to third embodiments described above, the supervised learning has been mainly described, but the present disclosure is not limited thereto. For example, the first to third embodiments may be applied to unsupervised learning or reinforcement learning.

A program (information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### Supplements

### Supplementary Note 1

A communication method in a mobile communication system, the communication method including:
transmitting, by a transmission-end entity to a reception-end entity, first use condition information representing a first use condition under which model data is to be used, the model data representing a training model and/or a data set, in which
the training model is one of an untrained model that has not been trained and a trained model that has been trained, and the data set is one of training data and inference data.

### Supplementary Note 2

The communication method according to Supplementary Note 1, in which the transmitting includes transmitting, by the transmission-end entity, the first use condition information and the model data.

### Supplementary Note 3

The communication method according to Supplementary Note 1 or 2, in which the transmitting includes transmitting, by the transmission-end entity, the model data after transmitting the first use condition information.

### Supplementary Note 4

The communication method according to any one of Supplementary Notes 1 to 3, in which the transmitting includes transmitting, by the transmission-end entity, the first use condition information to the reception-end entity using an information element including the first use condition information.

### Supplementary Note 5

The communication method according to any one of Supplementary Notes 1 to 4, in which the transmitting includes transmitting, by the transmission-end entity, the first use condition information to the reception-end entity using a predetermined bit string to which presence or absence of the first use condition information is mapped.

### Supplementary Note 6

The communication method according to any one of Supplementary Notes 1 to 5, in which the reception-end entity is a user equipment, and
the communication method further includes the steps of:
transmitting, by the user equipment, second use condition information representing a second use condition under which the training model is to be used to a network node based on the first use condition information; and
connecting, by the user equipment, to a cell satisfying the second use condition.

### Supplementary Note 7

The communication method according to any one of Supplementary Notes 1 to 6, further including:
performing, by the network node, processing of causing the user equipment to connect to the cell satisfying the second use condition, in which
the connecting includes connecting, by the user equipment, to the cell in accordance with the processing.

### Supplementary Note 8

The communication method according to any one of Supplementary Notes 1 to 7, in which the transmission-end entity is an access mobility management apparatus, and the reception-end entity is a user equipment; and
the transmitting includes transmitting, by the access mobility management apparatus to the user equipment, slice priority information representing a priority per slice, and the slice priority information includes the first use condition information.

### Supplementary Note 9

A communication method in a mobile communication system, the communication method including:
transmitting, by a transmission-end entity, a data set configured to be used in a training model to a reception-end entity including the training model without transmitting name information representing a name of the training model, in which
the training model is one of an untrained model that has not been trained and a trained model that has been trained, and
the data set is one of training data and inference data.

### REFERENCE SIGNS

1: Mobile communication system
20: 5GC (CN)
100: UE
110: Receiver
120: Transmitter
130: Controller
131: CSI generator
132: Optimum beam determiner
133: Position information generator
150: GNSS receiver
200: gNB
210: Transmitter
220: Receiver
230: Controller
A1: Data collector
A2: Model training unit
A3: Model inferrer
A4: Data processor
TE: Transmission-end entity
RE: Reception-end entity

1. A communication method in a mobile communication system, the communication method comprising:
transmitting, by a transmission-end entity to a reception-end entity, first use condition information representing a first use condition under which model data is to be used, the model data representing a training model and/or a data set, wherein
the training model is one of an untrained model that has not been trained and a trained model that has been trained, and
the data set is one of training data and inference data.

2. The communication method according to claim 1, wherein
the transmitting comprises transmitting, by the transmission-end entity, the first use condition information and the model data.

3. The communication method according to claim 1, wherein
the transmitting comprises transmitting, by the transmission-end entity, the model data after transmitting the first use condition information.

4. The communication method according to claim 1, wherein
the transmitting comprises transmitting, by the transmission-end entity, the first use condition information to the reception-end entity using an information element comprising the first use condition information.

5. The communication method according to claim 1, wherein
the transmitting comprises transmitting, by the transmission-end entity, the first use condition information to the reception-end entity using a predetermined bit string to which presence or absence of the first use condition information is mapped.

6. The communication method according to claim 1, wherein
the reception-end entity is a user equipment, and
the communication method further comprises the steps of:
transmitting, by the user equipment, second use condition information representing a second use condition under which the training model is to be used to a network node based on the first use condition information; and
connecting, by the user equipment, to a cell satisfying the second use condition.

7. The communication method according to claim 6, further comprising:
performing, by the network node, processing of causing the user equipment to connect to the cell satisfying the second use condition, wherein
the connecting comprises connecting, by the user equipment, to the cell in accordance with the processing.

8. The communication method according to claim 1, wherein
the transmission-end entity is an access mobility management apparatus, and the reception-end entity is a user equipment, and
the transmitting comprises transmitting, by the access mobility management apparatus to the user equipment, slice priority information representing a priority per slice, and
the slice priority information comprises the first use condition information.

9. A communication method in a mobile communication system, the communication method comprising:
transmitting, by a transmission-end entity, a data set configured to be used in a training model to a reception-end entity comprising the training model without transmitting name information representing a name of the training model, wherein
the training model is one of an untrained model that has not been trained and a trained model that has been trained, and
the data set is one of training data and inference data.

10. A user equipment in a mobile communication system, the user equipment comprising:
a receiver circuitry, receiving, from an access mobility management apparatus, first use condition information representing a first use condition under which model data is to be used, the model data representing a training model and/or a data set, wherein
the training model is one of an untrained model that has not been trained and a trained model that has been trained, and
the data set is one of training data and inference data.
